(19) United States
(12) Patent Application Publication
(10) Pub. No.: US 2025/0249353 A1
(43) Pub. Date: Aug. 7, 2025

(54) Calibration Method and Driving Method for Force Feedback Apparatus, Devices, and Storage Mediums

(71) Applicant: Goertek Inc., Weifang, Shandong (CN)

(72) Inventors: Xinfeng Yang, Shandong (CN); Bing Liu, Shandong (CN); Honglei Song, Shandong (CN)

(73) Assignee: Goertek Inc., Weifang, Shandong (CN)

(21) Appl. No.: 18/856,222

(22) PCT Filed: Mar. 9, 2023
(86) PCT No.: PCT/CN2023/080545

§ 371 Date: Oct. 11, 2024

(30) Foreign Application Priority Data
Apr. 11, 2022 (CN) 202210375951.1

(51) Int. Cl. A63F 13/285; A63F 13/22

(52) U.S. Cl. CPC A63F 13/285; A63F 13/22

(57) ABSTRACT

The disclosure includes a calibration method and a driving method for a force feedback apparatus, devices therefor, and storage media. The calibration method includes: when the force feedback apparatus is not powered on, adjusting a travel of a mover of the force feedback apparatus and measuring an outward output force of the force feedback apparatus, to measure a first correspondence between single-body characteristic forces and the travel of the force feedback apparatus; when the force feedback apparatus is driven according to a preset driving mode, adjusting the travel of the mover and measuring the outward output force of the force feedback apparatus, to measure a second correspondence between an electromagnetic force and the travel of the force feedback apparatus under the preset driving mode; and outputting the first correspondence and the second correspondence; to drive the force feedback apparatus.

### CROSS-REFERENCE TO RELATED APPLICATIONS

The present disclosure is a National Stage of International Application No. PCT/CN2023/080545 filed on Mar. 9, 2023, which claims priority to a Chinese patent application No. 202210375951.1 filed with the China National Intellectual Property Administration on Apr. 11, 2022, both of which are hereby incorporated by reference in their entireties.

### TECHNICAL FIELD

The present disclosure relates to the technical field of force feedback, particularly involving a calibration method and a driving method for a force feedback apparatus, devices, and storage media.

### BACKGROUND

A force feedback apparatus provides force sensation feedback that matches the operation, offering users a realistic experience. With the rise of the metaverse concept, the demand for force feedback in gaming controllers, AR/VR, and similar devices has also been increasing. A force feedback apparatus based on the principle of electromagnetic direct drive, utilizing the electromagnetic force exerted on energized coils located at the stator end within a magnetic field, applies an equal and opposite reaction force to the mover, thereby generating an outward output force and forming a force feedback effect. By controlling the magnitude and direction of the current, it is possible to precisely control the electromagnetic force, thereby achieving different force feedback effects. However, in actual processes, the outward output force generated by the force feedback apparatus is often the result of superimposing the reaction force with the outward output force caused by the single-body characteristics of the force feedback apparatus (such as spring force, static magnetic field interaction forces, etc.). Using the electromagnetic force as the outward output force for control will lead to difference between the actual outward output force of the force feedback apparatus and the expected output force thereof, thereby resulting in poor force feedback effects.

### SUMMARY

The main objective of the present disclosure is to provide a calibration method and a driving method for a force feedback apparatus, devices, and storage media, aiming to reduce the difference between the actual outward output force of the force feedback apparatus and the expected output force thereof by using data reflecting the single-body characteristics of the force feedback apparatus as the basis for controlling the outward output force, thereby improving the force feedback effect.

To achieve the above objectives, the present disclosure provides a calibration method for a force feedback apparatus, wherein the force feedback apparatus is based on the principle of electromagnetic direct drive. The method includes the following steps:
when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus, wherein the single-body characteristic forces are outward output forces caused by single-body characteristics of the force feedback apparatus;
when the force feedback apparatus is driven according to a preset driving mode, adjusting the travel of the mover via the test jig and measuring the outward output force of the force feedback apparatus via the force sensor, in order to, taking into account the first correspondence, measure a second correspondence between an electromagnetic force and the travel of the force feedback apparatus under the preset driving mode; and
outputting the first correspondence and the second correspondence, in order to enable a controller of the force feedback apparatus to determine a target driving mode according to a current travel of the mover, a target output force, the first correspondence, and the second correspondence, and to drive the force feedback apparatus according to the target driving mode.

Optionally, the step “when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus” includes:
when the force feedback apparatus is not powered on, adjusting a travel of a mover of the force feedback apparatus in the forward motion direction via a test jig and measuring an outward output force of the force feedback apparatus via a force sensor, in order to measure a third correspondence between a resultant force of single-body characteristic forces and the travel of the force feedback apparatus;
when the force feedback apparatus is not powered on, adjusting the travel of the mover in the reverse motion direction via the test jig and measuring the outward output force of the force feedback apparatus via the force sensor, in order to measure a fourth correspondence between a resultant force of the single-body characteristic forces and the travel; and
calculating a fifth correspondence between a friction force and the travel of the force feedback apparatus and a sixth correspondence between other characteristic forces and the travel of the force feedback apparatus based on the third correspondence and the fourth correspondence, and using the fifth correspondence and the sixth correspondence as the first correspondence;
wherein the friction force is one type of the single-body characteristic forces, and the other characteristic forces are the remaining forces of the single-body characteristic forces excluding the friction force.

Optionally, the step of “outputting the first correspondence and the second correspondence” includes:
acquiring identification information of the force feedback apparatus; and
binding the first correspondence and the second correspondence with the identification information before uploading them to a preset server, in order to enable the controller of the force feedback apparatus to retrieve the first correspondence and the second correspondence from the preset server according to the identification information.

To achieve the above objectives, the present disclosure also provides a driving method for a force feedback apparatus, wherein the force feedback apparatus is based on the principle of electromagnetic direct drive. The method includes the following steps:
acquiring a current travel of a mover of the force feedback apparatus and a target output force corresponding to the current travel;
determining a target driving mode according to the current travel, the target output force, a first correspondence, and a second correspondence, wherein the first correspondence is a correspondence between single-body characteristic forces and a travel of the mover of the force feedback apparatus, the second correspondence is a correspondence between an electromagnetic force and the travel of the mover of the force feedback apparatus under a preset driving mode, and the single-body characteristic forces are outward output forces caused by single-body characteristics of the force feedback apparatus; and
driving the force feedback apparatus according to the target driving mode.

Optionally, the step of “determining a target driving mode according to the current travel, the target output force, a first correspondence, and a second correspondence” includes:
determining current single-body characteristic forces corresponding to the current travel according to the first correspondence;
determining a target electromagnetic force of the force feedback apparatus according to the target output force and the current single-body characteristic forces;
determining a first estimated electromagnetic force corresponding to the current travel under the preset driving mode according to the second correspondence; and
determining a target driving mode according to the target electromagnetic force and the first estimated electromagnetic force.

Optionally, after the step of “determining a target driving mode according to the current travel, the target output force, a first correspondence, and a second correspondence”, the method further includes:
determining a second estimated electromagnetic force of the force feedback apparatus under the target driving mode and the current travel according to the first estimated electromagnetic force and the target driving mode;
determining an estimated output force of the force feedback apparatus according to the second estimated electromagnetic force and the current single-body characteristic forces; and
generating relational data representing a correspondence between the estimated output force and the current travel, and outputting the relational data.

Optionally, the step of “determining current single-body characteristic forces corresponding to the current travel according to the first correspondence” includes:
determining a current friction force corresponding to the current travel according to a fifth correspondence included in the first correspondence;
determining current other characteristic forces corresponding to the current travel according to a sixth correspondence included in the first correspondence;
wherein the fifth correspondence is a correspondence between a friction force and the travel of the mover of the force feedback apparatus, and the sixth correspondence is a correspondence between other characteristic forces and the travel of the mover of the force feedback apparatus, the friction force being one type of the single-body characteristic forces, and the other characteristic forces being the remaining forces of the single-body characteristic forces excluding the friction force;
the step of “determining a target electromagnetic force of the force feedback apparatus according to the target output force and the current single-body characteristic forces” includes:
when the current motion direction of the mover is the forward motion direction, subtracting the sum of the current other characteristic forces and the current friction force from the target output force to obtain the target electromagnetic force of the force feedback apparatus;
when the current motion direction of the mover is the reverse motion direction, subtracting the difference between the current other characteristic forces and the current friction force from the target output force to obtain the target electromagnetic force of the force feedback apparatus.

Optionally, the preset driving mode is to output a forward voltage with a preset duty cycle, the step of “determining a target driving mode according to the target electromagnetic force and the first estimated electromagnetic force” includes:
calculating a ratio between the target electromagnetic force and the first estimated electromagnetic force, and determining a target duty cycle according to the ratio and the preset duty cycle;
when the target duty cycle is greater than or equal to zero, setting “outputting a forward voltage with the target duty cycle” as the target driving mode;
when the target duty cycle is less than zero, setting “outputting a reverse voltage with a duty cycle equal to the absolute value of the target duty cycle” as the target driving mode.

Optionally, before the step of “acquiring a current travel of a mover of the force feedback apparatus and a target output force corresponding to the current travel”, the method further includes:
acquiring identification information of the force feedback apparatus; and
downloading the first correspondence and the second correspondence corresponding to the identification information from a preset server.

To achieve the above objectives, the present disclosure also provides a calibration device for a force feedback apparatus. The calibration device includes: a memory, a processor, and a calibration program for the force feedback apparatus stored on the memory and operable on the processor. When executed by the processor, the calibration program implements the steps of the calibration method for the force feedback apparatus as described above.

To achieve the above objectives, the present disclosure also provides a driving device for a force feedback apparatus. The driving device includes: a memory, a processor, and a driving program for the force feedback apparatus stored on the memory and operable on the processor. When executed by the processor, the driving program implements the steps of the driving method for the force feedback apparatus as described above.

To achieve the above objectives, the present disclosure also proposes a computer-readable storage medium. The computer-readable storage medium stores a calibration program for a force feedback apparatus. When executed by a processor, the calibration program implements the steps of the calibration method for the force feedback apparatus as described above.

In addition, to achieve the above objectives, the present disclosure also proposes a computer-readable storage medium. The computer-readable storage medium stores a driving program for a force feedback apparatus. When executed by a processor, the driving program implements the steps of the driving method for the force feedback apparatus as described above.

In the present disclosure, when the force feedback apparatus is not powered on, adjust a travel of a mover of the force feedback apparatus via a test jig and measuring an outward output force of the force feedback apparatus via a force sensor, in order to measure a first correspondence between single-body characteristic forces and the travel of the force feedback apparatus; when the force feedback apparatus is driven according to a preset driving mode, adjust the travel of the mover via the test jig and measuring the outward output force of the force feedback apparatus via the force sensor, in order to, taking into account the first correspondence, measure a second correspondence between an electromagnetic force and the travel of the force feedback apparatus under the preset driving mode; and output the first correspondence and the second correspondence, in order to enable a controller of the force feedback apparatus to determine a target driving mode according to a current travel of the mover, a target output force, the first correspondence, and the second correspondence, and to drive the force feedback apparatus according to the target driving mode. By calibrating the single-body characteristics of the force feedback apparatus, the present disclosure obtains the first correspondence and the second correspondence that reflect the single-body characteristics of the force feedback apparatus, serving as the basis for the controller to drive the force feedback apparatus and control the outward output force. This reduces the difference between the actual outward output force of the force feedback apparatus and the expected output force thereof, thereby improving the force feedback effect.

### BRIEF DESCRIPTION OF THE DRAWINGS

FIG. 1 is a flowchart illustrating the first embodiment of the calibration method for the force feedback apparatus of the present disclosure;

FIG. 2 is a flowchart illustrating the calibration process of a force feedback apparatus involved in the embodiments of the present disclosure;

FIG. 3 is a flowchart illustrating the driving process of a force feedback apparatus involved in the embodiments of the present disclosure; and

FIG. 4 is an architectural diagram illustrating the calibration and driving system of a force feedback apparatus involved in the embodiments of the present disclosure.

The realization of the objectives, functional features, and advantages of the present disclosure will be further explained with reference to the accompanying drawings in conjunction with the embodiments.

### DETAILED DESCRIPTION

It should be understood that the specific embodiments described herein are merely for explaining the present disclosure and are not intended to limit the present disclosure.

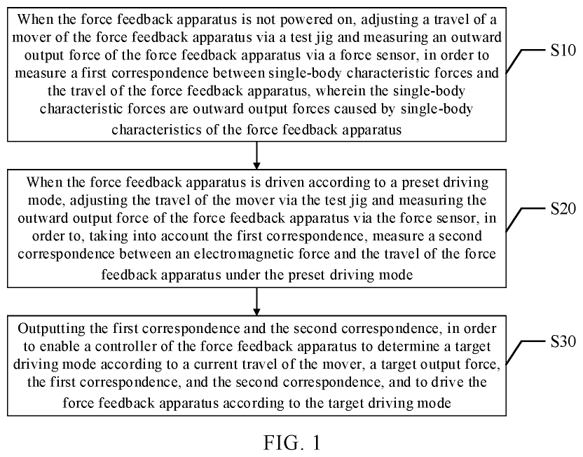

Referring to FIG. 1, FIG. 1 is a flowchart illustrating the first embodiment of the calibration method for the force feedback apparatus of the present disclosure.

The embodiments of the present disclosure provide examples of the calibration method for a force feedback apparatus. It should be noted that although the logical sequence is shown in the flowcharts, in some cases, the steps depicted or described may be performed in a different order than shown here. In this embodiment, the calibration method for the force feedback apparatus can be applied to devices such as computers, smartphones, servers, etc., without limitation. For the sake of description, the following explanation will use the calibration device as the executing entity. In this embodiment, the calibration method for the force feedback apparatus includes:

Step S10: when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus, wherein the single-body characteristic forces are outward output forces caused by single-body characteristics of the force feedback apparatus.

In this embodiment, to address the issue of difference between the actual outward output force of the force feedback apparatus and the expected output force thereof, the following method is proposed: by calibrating the single body of the force feedback apparatus, obtain data that reflects the single-body characteristics of the force feedback apparatus, serving as the basis for controlling the outward output force. This reduces the difference between the actual outward output force of the force feedback apparatus and the expected output force thereof, thereby improving the force feedback effect.

Specifically, a force feedback apparatus based on the principle of electromagnetic direct drive consists of two parts: the mover and the stator. The working principle is that energized coils at the stator end will experience electromagnetic forces in a magnetic field, which in turn apply an equal and opposite reaction force to the mover. The mover can move back and forth within a certain range. During the movement, the mover experiences forces other than the reaction force. Due to the process and instability factors of manufacture of the force feedback apparatus, these forces vary among different single-bodies of the force feedback apparatus under the same conditions. The resultant force of these forces with the reaction force constitutes the outward output force of the force feedback apparatus. These forces are referred to hereinafter as the outward output forces caused by the single-body characteristics of the force feedback apparatus, and are further simplified as single-body characteristic forces. Single-body characteristic forces may include various types, such as friction forces, spring forces, static magnetic field interaction forces (static magnetic forces). In one embodiment, at least one of the mover and the stator contains a permanent magnet, and at least one of them contains a coil. The coil end is paired with magnetic materials to enhance the electromagnetic force after electrification. Since the coil needs to be connected to a power source for operation, the magnetic steel and the coil are designed at the stator end. The mover and the stator are connected through necessary connecting components, which can be springs.

In this embodiment, the calibration device is used to calibrate the force feedback apparatus. In specific implementations, the operation of calibrating the force feedback apparatus using the calibration device can be completed on the production line or in other scenarios, with no limitations imposed.

Under the condition that it is determined that the force feedback apparatus is not powered on, a calibration device adjusts the travel of the mover of the force feedback apparatus using a test jig and measures the outward output forces of the force feedback apparatus through a force sensor during this process.

Here, the operation of powering or not powering the force feedback apparatus is referred to as a driving operation, and applying different voltages or currents to the force feedback apparatus constitutes different driving modes. During the calibration process, the driving operations of the force feedback apparatus can be performed by a controller that is paired with the force feedback apparatus or by a controller equipped on the production line, with no limitations imposed in this embodiment. There are many methods for determining how the force feedback apparatus is driven, such as setting by the tester in the calibration device or reporting by the controller of the force feedback apparatus, with no limitations imposed in this embodiment. For example, in one implementation, the calibration device can connect to the controller of the force feedback apparatus and send instructions to ensure that the controller does not power the force feedback apparatus. In one implementation, the controller can achieve not powering the force feedback apparatus by outputting a voltage with a duty cycle of 0.

In the following, the term “travel” is used to represent the position of the mover during its motion. Whether the position is represented using distance or percentage and the selection of the position reference point are not limited in this embodiment. For example, in one implementation, the start point could be one end of the movable range of the mover, and the terminal point could be the other end. The ratio of the distance traveled from the start point to the current position to the total distance from the start point to the terminal point is referred to as the travel.

The test jig can be a device capable of adjusting the travel of the mover. In specific implementations, by controlling the degree of pressing the mover with the test jig, the travel of the mover can be changed. The force sensor can be used to simulate the force experienced by the user from the outward output force of the force feedback apparatus (hereinafter referred to as the outward output force). During the process of adjusting the travel with the test jig, the force sensor measures the outward output force of the force feedback apparatus at different travels. The calibration device acquires the travel from the test jig and the outward output force from the force sensor, thus obtaining the correspondence between the outward output force and the travel. In one implementation, the calibration device can send instructions to the test jig to adjust the travel of the mover through the test jig and acquire the corresponding outward output force at different travels through the force sensor.

It should be noted that during the movement, the mover will be at different positions, and at each position, the single-body characteristic forces are different. The aforementioned travel adjustment process is carried out when the force feedback apparatus is not powered on, meaning no electromagnetic force is generated by the force feedback apparatus, and no reaction force is applied to the mover. Therefore, the measured outward output force can be considered as the single-body characteristic force of the force feedback apparatus.

In specific implementations, multiple single-body characteristic forces can be considered as a whole or individually. When considering them as a whole, the calibration device can obtain the correspondence between the resultant force of the single-body characteristic forces and the travel based on the correspondence between the measured outward output force and the travel, and this correspondence is referred to as the first correspondence. When considering them individually, the calibration device can calculate the correspondence between different single-body characteristic forces and the travel based on the correspondence between the measured outward output force and the travel, and all of these correspondences are referred to as the first correspondence.

Because when the direction of the mover's movement changes, the direction of the friction force acting on the mover also changes, friction force, as a type of single-body characteristic force, may contribute to or diminish the outward output force of the force feedback apparatus; that is, when the direction of the friction force is the same as the direction of the reaction force, the friction force contributes to the outward output force, making the outward output force the sum of the magnitudes of the friction force, the reaction force (also referred to as the electromagnetic force when only magnitude, not direction, is considered), and other single-body characteristic forces (referred to as other characteristic forces hereafter); whereas when the direction of the friction force is opposite to the direction of the reaction force, the friction force diminishes the outward output force, which is then the sum of the magnitudes of the reaction force and other single-body characteristic forces minus the magnitude of the friction force. Based on the above principle, when the direction of the mover's movement changes, even though the travel remains the same, the resultant force of the single-body characteristic forces differs. Here, other characteristic forces refer to all other single-body characteristic forces excluding friction force. It should be noted that when the movement direction changes but the travel remains the same, the magnitude and direction of the electromagnetic force remain constant, as do the other characteristic forces.

In one implementation, if the friction force acting on the mover (of the force feedback apparatus) during its movement can be considered negligible, the single-body characteristic forces can be considered as a whole. When adjusting the travel of the mover using the test jig, adjustments can be made in one motion direction to measure the correspondence between the resultant force of the single-body characteristic forces and the travel when the mover moves in that direction. This correspondence is referred to as the first correspondence. In another implementation, the friction force can also be taken into account. By adjusting the travel of the mover in one motion direction using the test jig, the correspondence between the resultant force of the single-body characteristic forces and the travel can be obtained when the mover is moving in this motion direction. Then, by adjusting the travel of the mover in another motion direction using the test jig, the correspondence between the resultant force of the single-body characteristic forces and the travel can be obtained when the mover moves in that other direction. Both of these correspondences are collectively referred to as the first correspondence. In yet another implementation, when taking the friction force into account, the single-body characteristic forces can also be considered separately. That is, the correspondence between the friction force (here means the magnitude thereof) and the travel can be measured, as well as the correspondence between the other characteristic forces and the travel, with both of these correspondences collectively referred to as the first correspondence.

Step S20, when the force feedback apparatus is driven according to a preset driving mode, adjusting the travel of the mover via the test jig and measuring the outward output force of the force feedback apparatus via the force sensor, in order to, taking into account the first correspondence, measure a second correspondence between an electromagnetic force and the travel of the force feedback apparatus under the preset driving mode.

When the force feedback apparatus is driven according to different driving modes, the magnitude of the electromagnetic force produced by the force feedback apparatus is different, leading to different reaction forces exerted on the mover, and consequently, the outward output force of the force feedback apparatus is also different. When the force feedback apparatus is powered on, the magnitude of the electromagnetic force produced by the force feedback apparatus varies at different positions of the mover, leading to different reaction forces exerted on the mover, and consequently, the outward output force of the force feedback apparatus is also different.

When it is determined that the force feedback apparatus is being driven according to the preset driving mode, the calibration device can adjust the travel of the mover using the test jig and, during this process, measure the outward output force of the force feedback apparatus through the force sensor, thus obtaining the correspondence between the outward output force and the travel.

Here, the preset driving mode can be one or more driving modes predefined, with no limitations imposed in this embodiment. For example, the preset driving mode can be a forward voltage with a 100% duty cycle. In one implementation, the calibration device can connect to the controller of the force feedback apparatus, send instructions to the controller so that the controller drives the force feedback apparatus according to the preset driving mode.

It should be noted that the aforementioned travel adjustment process is carried out when the force feedback apparatus is driven according to the preset driving mode. The force feedback apparatus generates an electromagnetic force corresponding to the preset driving mode, and the mover experiences a corresponding reaction force. Therefore, the measured outward output force can be considered as the sum of the magnitude of the electromagnetic force generated under the preset driving mode and the single-body characteristic force of the force feedback apparatus. Thus, based on the already obtained first correspondence between the single-body characteristic force and the travel, by excluding, from the measured outward output force of the force feedback apparatus, the single-body characteristic force at the same travel when driven according to the preset driving mode, the second correspondence between the electromagnetic force and the travel of the force feedback apparatus under the preset driving mode can be obtained. It should be noted that when there are multiple preset driving modes, the calibration device measures the second correspondence between the electromagnetic force and the travel of the force feedback apparatus for each preset driving mode respectively.

In a specific implementation, depending on how the single-body characteristic forces are considered when measuring the first correspondence, the method of excluding the single-body characteristic forces at the same travel from the measured outward output force of the force feedback apparatus when driven according to the preset driving mode also varies.

In one implementation, when the single-body characteristic forces are considered as a whole and the friction force is negligible, the calibration device takes the correspondence between the resultant force of the single-body characteristic forces and the travel, measured while adjusting the mover's travel in one motion direction, as the first correspondence. Accordingly, when driving the force feedback apparatus according to the preset driving mode, the calibration device can also adjust the mover's travel using the test jig in that motion direction and measure the correspondence between the outward output force and the travel when the mover moves in that direction. By subtracting the resultant force of the single-body characteristic forces corresponding to the same travel from the first correspondence from the outward output force at each travel, the calibration device can obtain the correspondence between the electromagnetic force and the travel, and take this correspondence as the second correspondence. In another implementation, when the single-body characteristic forces are considered as a whole and the friction force is also taken into account, the method described above can be used to measure in each of two directions of movement respectively a set of correspondences between the electromagnetic force and the travel, and then average the electromagnetic forces corresponding to the same travel in the two sets of correspondences to obtain a set of correspondences between the electromagnetic force and the travel, and take these correspondences as the second correspondence. In another implementation, when the friction force is taken into account and the single-body characteristic forces are considered separately, the calibration device measures the correspondence between the friction force and the travel, as well as the correspondence between the other characteristic forces and the travel. After measuring the correspondence between the outward output force and the travel in one motion direction when driving the force feedback apparatus according to the preset driving mode, the calibration device can exclude the friction force and other characteristic forces corresponding to the same travel from the outward output forces according to the superposition manner of the friction force, other characteristic forces, and the electromagnetic force in that motion direction, thus obtaining the electromagnetic force, and then obtain a set of correspondences between the electromagnetic force and the travel, taking these correspondences as the second correspondence.

Step S30, outputting the first correspondence and the second correspondence, in order to enable a controller of the force feedback apparatus to determine a target driving mode according to a current travel of the mover, a target output force, the first correspondence, and the second correspondence, and to drive the force feedback apparatus according to the target driving mode.

After measuring the first correspondence and the second correspondence, the calibration device can output the first correspondence and the second correspondence. The purpose of the output is to allow the controller of the force feedback apparatus to obtain the first correspondence and the second correspondence, thereby determining the driving mode for the force feedback apparatus based on these correspondences. The specific method of output is not restricted in this embodiment. For example, in one implementation, the calibration device can output the first correspondence and the second correspondence to a storage device, from which the controller retrieves them when needed.

After the controller obtains the first correspondence and the second correspondence of the force feedback apparatus, it can save these correspondences. When it is necessary to drive the force feedback apparatus, the controller can retrieve and use the first correspondence and the second correspondence.

The controller can determine the driving mode (hereinafter referred to as the target driving mode) based on the current travel of the mover, the target output force, the first correspondence, and the second correspondence. The target driving mode is a driving mode corresponds to the target output force, meaning that the purpose of driving the force feedback apparatus with this target driving mode is to make the actual outward output force of the force feedback apparatus reach the level of the target output force. In a specific implementation, the controller can detect the current travel of the mover through a Hall element or other position sensors. The target output force is the outward output force required to be produced at the current travel. In a specific implementation, the controller can obtain the correspondence between different travels and their required outward output forces, and determine the target output force corresponding to the current travel based on this correspondence. The correspondence between different travels and the required outward output forces can be acquired by the controller from the outside, for example, from a higher-level application. This correspondence can be determined according to the needs of the force feedback effect in the current application scenario of the force feedback apparatus, and the method of determination is not limited in this embodiment.

In one implementation, the controller can determine the target electromagnetic force based on the current travel, the target output force, the first correspondence, and the second correspondence, and then determine the target driving mode based on the target electromagnetic force. The target electromagnetic force is the magnitude of the electromagnetic force required to achieve the target output force. Furthermore, in one implementation, the controller can determine the single-body characteristic forces at the current travel based on the first correspondence, and then exclude the single-body characteristic forces from the target output force to obtain the target electromagnetic force. Furthermore, in one implementation, the controller can determine the estimated electromagnetic force corresponding to the current travel under the preset driving mode based on the second correspondence, and then determine the target driving mode based on the estimated electromagnetic force and the target electromagnetic force.

Furthermore, in one implementation, step S30 includes:

Step S301: acquiring identification information of the force feedback apparatus; and

Step S302: binding the first correspondence and the second correspondence with the identification information before uploading them to a preset server, in order to enable the controller of the force feedback apparatus to retrieve the first correspondence and the second correspondence from the preset server according to the identification information.

In practical application scenarios, the force feedback apparatus and the controller may be independently provided. After users purchase the force feedback apparatus and the controller, they pair the two apparatuses for use. At this point, the paired controller needs to adopt the first correspondence and the second correspondence corresponding to the force feedback apparatus to determine the driving mode and then drive the apparatus accordingly. In this implementation, to ensure that the controller can acquire the first correspondence and the second correspondence of the temporarily paired force feedback apparatus during the usage phase, the calibration device can acquire the identification information of the force feedback apparatus, bind the first correspondence and the second correspondence with this identification information, and upload them to a preset server. This allows the controller of the force feedback apparatus to retrieve the first correspondence and the second correspondence of the force feedback apparatus according to the identification information from the preset server. In a specific implementation, the calibration device can obtain the identification information of the force feedback apparatus through manual entry or scanning with a code scanner, etc. The identification information can be carried in the form of a graphic code, a barcode, etc., and the identification information should be information that can uniquely identify the force feedback apparatus.

In this embodiment, when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus; when the force feedback apparatus is driven according to a preset driving mode, adjusting the travel of the mover via the test jig and measuring the outward output force of the force feedback apparatus via the force sensor, in order to, taking into account the first correspondence, measure a second correspondence between an electromagnetic force and the travel of the force feedback apparatus under the preset driving mode; outputting the first correspondence and the second correspondence, in order to enable a controller of the force feedback apparatus to determine a target driving mode according to a current travel of the mover, a target output force, the first correspondence, and the second correspondence, and to drive the force feedback apparatus according to the target driving mode. By calibrating the single-body of the force feedback apparatus, the first correspondence and the second correspondence that reflect the characteristics of the single-body of the force feedback apparatus are obtained, serving as the basis for the controller to drive the force feedback apparatus to control the outward output force, reducing the difference between the actual outward output force and the expected output force of the force feedback apparatus, thereby improving the force feedback effect.

Further, based on the aforementioned first embodiment, a second embodiment of the calibration method for the force feedback apparatus of the present disclosure is proposed. In this embodiment, step S10 includes:

Step S101: when the force feedback apparatus is not powered on, adjusting a travel of a mover of the force feedback apparatus in the forward motion direction via a test jig and measuring an outward output force of the force feedback apparatus via a force sensor, in order to measure a third correspondence between a resultant force of single-body characteristic forces and the travel of the force feedback apparatus;

In this embodiment, the single-body characteristic forces can be considered separately, and the friction force can be taken into account. Specifically, the calibration device can, upon determining that the force feedback apparatus has not been powered on, adjust the travel of the mover in the forward motion direction using the test jig and measure the outward output force of the force feedback apparatus through the force sensor during this process. Here, the forward motion direction and the reverse motion direction are opposite directions. In this embodiment, one of the directions in which the mover moves back and forth can be designated as the forward motion direction, and the other direction as the reverse direction, without specific limitations. Adjusting the travel of the mover in the forward motion direction means making the mover move in that forward motion direction. In one implementation, the calibration device can send instructions to the test jig so that the test jig adjust the travel of the mover in the forward motion direction according to the instructions and obtain the outward output forces corresponding to different travels via the force sensor.

The calibration device takes the correspondence between the outward output force and the travel when the mover moves in the forward motion direction as the correspondence between the resultant force of the single-body characteristic forces and the travel when the mover moves in the forward motion direction (hereinafter referred to as the third correspondence, for differentiation).

Step S102: when the force feedback apparatus is not powered on, adjusting the travel of the mover in the reverse motion direction via the test jig and measuring the outward output force of the force feedback apparatus via the force sensor, in order to measure a fourth correspondence between a resultant force of the single-body characteristic forces and the travel.

The calibration device can, upon determining that the force feedback apparatus has not been powered on, adjust the travel of the mover in the reverse motion direction using the test jig and measure the outward output forces of the force feedback apparatus through the force sensor during this process. In one implementation, the calibration device can send instructions to the test jig, so that the test jig adjust the travel of the mover in the reverse motion direction according to the instructions and obtain the outward output forces corresponding to different travels via the force sensor.

The calibration device takes the correspondence between the outward output forces and the travel when the mover moves in the reverse motion direction as the correspondence between the resultant force of the single-body characteristic forces and the travel when the mover moves in the reverse motion direction (hereinafter referred to as the fourth correspondence, for differentiation).

Step S103: calculating a fifth correspondence between a friction force and the travel of the force feedback apparatus and a sixth correspondence between other characteristic forces and the travel of the force feedback apparatus based on the third correspondence and the fourth correspondence, and using the fifth correspondence and the sixth correspondence as the first correspondence; wherein the friction force is one type of the single-body characteristic forces, and the other characteristic forces are the remaining forces of the single-body characteristic forces excluding the friction force.

After obtaining the third correspondence and the fourth correspondence, the calibration device can calculate the correspondence between the friction force and the travel of the force feedback apparatus (referred to as the fifth correspondence hereinafter) and the correspondence between the other characteristic forces and the travel (referred to as the sixth correspondence hereinafter). Among these, the friction force refers to the friction force experienced by the mover. The fifth correspondence only considers the correspondence between the magnitude of the friction force and the travel, without considering its direction. It can be understood that the magnitude of the friction force of the force feedback apparatus is the same at the same travel, but the direction is opposite. It should be noted that, in the third correspondence and the fourth correspondence, the components of the resultant force of the single-body characteristic forces corresponding to the same travel for the other characteristic forces have the same magnitude and direction, while the components for the friction force have the same magnitude but opposite directions. Therefore, the correspondence between the other characteristic forces and the travel can be obtained by adding the resultant forces of the single-body characteristic forces corresponding to the same travel in the third correspondence and the fourth correspondence. The correspondence between the friction force and the travel can be obtained by subtracting the resultant forces of the single-body characteristic forces corresponding to the same travel in the third correspondence and the fourth correspondence.

In one implementation, when the direction of the friction force during the mover's motion is the same as the direction of the reaction force, the resultant forces of the single-body characteristic forces corresponding to the same travel in the third correspondence and the fourth correspondence can be added together and then divided by two to obtain the correspondence between the other characteristic forces and the travel. The resultant force of the single-body characteristic forces in the fourth correspondence can be subtracted from the resultant force of the single-body characteristic forces corresponding to the same travel in the third correspondence and then divided by two to obtain the correspondence between the friction force and the travel.

Further, based on the aforementioned first embodiment and/or second embodiment, a third embodiment of the driving method for the force feedback apparatus of the present invention is proposed. In this embodiment, the driving method for the force feedback apparatus can be applied to the controller of the force feedback apparatus; the controller and the force feedback apparatus can be deployed in devices requiring force feedback functions, such as game controllers in VR/AR devices; there are no specific restrictions in this embodiment. For the sake of description, the following details will be presented with the controller as the executing entity. The driving method for the force feedback apparatus includes:

Step A10: acquiring a current travel of a mover of the force feedback apparatus and a target output force corresponding to the current travel;

Step A20: determining a target driving mode according to the current travel, the target output force, a first correspondence, and a second correspondence, wherein the first correspondence is a correspondence between single-body characteristic forces and a travel of the mover of the force feedback apparatus, the second correspondence is a correspondence between an electromagnetic force and the travel of the mover of the force feedback apparatus under a preset driving mode, and the single-body characteristic forces are outward output forces caused by single-body characteristics of the force feedback apparatus; and

Step A30: driving the force feedback apparatus according to the target driving mode.

In this embodiment, the specific implementations of steps A10 to A30 can refer to the specific implementations of steps S10 to S30 in the aforementioned first embodiment, which are not elaborated here. In a specific implementations, the first correspondence and the second correspondence of the force feedback apparatus can be pre-set in the controller or obtained by the controller from a server or other storage devices. The methods for obtaining the first correspondence and the second correspondence of the force feedback apparatus can refer to the aforementioned first or second embodiments, or can be determined by testers based on data obtained from the test jig and force sensors; there are no specific restrictions.

Further, in one implementation, prior to step A10, the method also includes:

Step A40: acquiring identification information of the force feedback apparatus;

Step A50: downloading the first correspondence and the second correspondence corresponding to the identification information from a preset server.

The specific implementations of steps A40 and A50 can refer to the specific implementations of steps S301 and S302 in the aforementioned first embodiment, which are not elaborated here.

In this embodiment, the current travel of the mover of the force feedback apparatus and the target output force corresponding to the current travel are acquired; the target driving mode is determined based on the current travel, the target output force, the first correspondence, and the second correspondence, wherein the first correspondence is the correspondence between the single-body characteristic forces and the travel of the mover of the force feedback apparatus; the second correspondence is the correspondence between the electromagnetic force and the travel of the mover of the force feedback apparatus under the preset driving mode. The single-body characteristic forces refer to the outward output forces caused by the single-body characteristics of the force feedback apparatus; the force feedback apparatus is driven according to the target driving mode. By utilizing the first correspondence and the second correspondence that reflect the single-body characteristics of the force feedback apparatus as the basis for the controller to drive the force feedback apparatus to control the outward output force, the difference between the actual outward output force and the expected output force of the force feedback apparatus is reduced, improving the force feedback effect.

Further, based on the aforementioned third embodiment, a fourth embodiment of the driving method for the force feedback apparatus of the present invention is proposed. In this embodiment, step A20 includes:

Step A201: determining current single-body characteristic forces corresponding to the current travel according to the first correspondence.

In this embodiment, the controller can determine the current single-body characteristic forces (hereinafter referred to as the current single-body characteristic forces) based on the first correspondence. That is, the current single-body characteristic forces characterize the single-body characteristic forces of the force feedback apparatus at the current travel. In a specific implementation, when the first correspondence is the correspondence between the resultant forces of the single-body characteristic forces and the travel, the current single-body characteristic forces refer to the resultant forces of the current single-body characteristic forces. When the first correspondence includes the respective correspondences between various single-body characteristic forces and the travel, the current single-body characteristic forces include the current various single-body characteristic forces, such as the current friction force and other characteristic forces.

Step A202: determining a target electromagnetic force of the force feedback apparatus according to the target output force and the current single-body characteristic forces;

The controller can determine the target electromagnetic force of the force feedback apparatus based on the target output force and the current single-body characteristic forces. Specifically, the controller can exclude the current single-body characteristic forces from the target output force to derive the target electromagnetic force.

Among these, in a specific implementation, depending on how the single-body characteristic forces are considered, the method of excluding the current single-body characteristic forces from the target output force also varies. For example, in one implementation, when the single-body characteristic forces are considered as a whole and the friction force is ignored, the first correspondence is the correspondence between the resultant forces of the single-body characteristic forces and the travel. The current single-body characteristic force that the controller obtains based on the first correspondence is the resultant force of the current single-body characteristic forces, and the controller can take the result of subtracting the current single-body characteristic forces from the target output force as the target electromagnetic force. In another implementation, when the single-body characteristic forces are considered as a whole but the friction force is also taken into account, the first correspondence includes the correspondences between the resultant forces of the single-body characteristic forces and the travel in both motion directions. The current single-body characteristic force that the controller obtains based on the first correspondence is the resultant force of the single-body characteristic forces corresponding to the current motion direction of the mover based on the first correspondence, and the controller takes the result of subtracting the current single-body characteristic forces from the target output force as the target electromagnetic force. In yet another implementation, when the single-body characteristic forces are considered individually, the first correspondence includes the correspondence between the friction force and the travel and the correspondence between the other characteristic forces and the travel. The current single-body characteristic force that the controller obtains based on the first correspondence includes the current friction force and the current other characteristic forces, and the controller excludes the current friction force and the current other characteristic forces from the target output force according to the superposition manner of the friction force, other characteristic forces, and the reaction force in the current motion direction of the mover to derive the target electromagnetic force.

Step A203: determining a first estimated electromagnetic force corresponding to the current travel under the preset driving mode according to the second correspondence.

The controller can determine the electromagnetic force (hereinafter referred to as the first estimated electromagnetic force) corresponding to the current travel under the preset driving mode based on the second correspondence. The first estimated electromagnetic force characterizes the electromagnetic force that the force feedback apparatus is expected to generate when driven under the preset driving mode at the current travel.

Step A204: determining a target driving mode according to the target electromagnetic force and the first estimated electromagnetic force.

The controller can determine the target driving mode based on the target electromagnetic force and the first estimated electromagnetic force. In this embodiment, depending on the selected preset driving mode, the method of determining the target driving mode based on the target electromagnetic force and the first estimated electromagnetic force differs. It can be understood that, under the preset driving mode, the force feedback apparatus is expected to produce the first estimated electromagnetic force. Based on the relationship between the electromagnetic forces produced by the force feedback apparatus under different driving modes, a target driving mode can be determined so that when the force feedback apparatus is driven under the target driving mode, the actual electromagnetic force produced can reach a level equivalent to the target electromagnetic force.

In one implementation, there can be multiple preset driving modes, for example, driving modes that output voltages with different duty cycles. The controller can obtain the first estimated electromagnetic forces under different preset driving modes based on the second correspondences corresponding to the different preset driving modes. By comparing the target electromagnetic force with each of the first estimated electromagnetic forces, the controller can select a first estimated electromagnetic force that is the same as the target electromagnetic force or has an error within a certain range, and use the preset driving mode corresponding to this first estimated electromagnetic force as the target driving mode.

Furthermore, in one implementation, after step A20, the method also includes:

Step A60: determining a second estimated electromagnetic force of the force feedback apparatus under the target driving mode and the current travel according to the first estimated electromagnetic force and the target driving mode.

In this implementation, the controller can determine the electromagnetic force (hereinafter referred to as the second estimated electromagnetic force) that the force feedback apparatus is expected to produce under the target driving mode and the current travel based on the first estimated electromagnetic force and the target driving mode.

It can be understood that under the preset driving mode, the force feedback apparatus is expected to produce the first estimated electromagnetic force. Based on the relationship between the electromagnetic forces produced by the force feedback apparatus under different driving modes, it can be predicted that when the force feedback apparatus is driven under the target driving mode, the electromagnetic force it can produce would be estimable. In one implementation, when there are multiple preset driving modes and the controller selects a first estimated electromagnetic force that is the same as the target electromagnetic force or has an error within a certain range, and uses the preset driving mode corresponding to this first estimated electromagnetic force as the target driving mode, the first estimated electromagnetic force can be used as the second estimated electromagnetic force.

Step A70: determining an estimated output force of the force feedback apparatus according to the second estimated electromagnetic force and the current single-body characteristic forces.

The controller can determine the estimated output force of the force feedback apparatus based on the second estimated electromagnetic force and the current single-body characteristic forces. Specifically, the controller can superpose the second estimated electromagnetic force to the current single-body characteristic forces to derive the estimated output force. The method of superposition is related to how the single-body characteristic forces are considered and the direction of the mover's motion, and can specifically refer to the inverse process of excluding the current single-body characteristic forces from the target output force as mentioned above.

Step A80: generating relational data representing a correspondence between the estimated output force and the current travel, and outputting the relational data.

After obtaining the estimated output force, the controller can generate relational data representing the correspondence between the estimated output force and the current travel, and output the relational data. Here, the travel of the mover is continuously changing, and the relational data includes data marking the estimated output forces corresponding to different travels. This can be specifically in the form of a table or a curve chart, etc., and is not specifically restricted in this embodiment. In a specific implementation, outputting the relational data can involve outputting it to a display device connected to the controller to display it, or storing it in a storage device connected to the controller for subsequent analysis by technicians or users.

Further, in one implementation, step A201 includes:

Step A2011: determining a current friction force corresponding to the current travel according to a fifth correspondence included in the first correspondence.

Step A2012: determining current other characteristic forces corresponding to the current travel according to a sixth correspondence included in the first correspondence. Here, the fifth correspondence is a correspondence between a friction force and the travel of the mover of the force feedback apparatus, and the sixth correspondence is a correspondence between other characteristic forces and the travel of the mover of the force feedback apparatus, the friction force being one type of the single-body characteristic forces, and the other characteristic forces being the remaining forces of the single-body characteristic forces excluding the friction force.

In this embodiment, the first correspondence can include the fifth correspondence and the sixth correspondence, i.e., the correspondence between the friction force and the travel and the correspondence between the other characteristic forces and the travel. The controller can determine the current friction force corresponding to the current travel based on the fifth correspondence and determine the current other characteristic forces corresponding to the current travel based on the sixth correspondence.

Step A202 includes:

Step A2021: when the current motion direction of the mover is the forward motion direction, subtracting the sum of the current other characteristic forces and the current friction force from the target output force to obtain the target electromagnetic force of the force feedback apparatus.

In this implementation, the direction in which the friction force acts in the same direction as the reaction force during the movement of the mover can be considered as the forward motion direction. The controller can determine the current motion direction of the mover, and when the current motion direction is the forward motion direction, the controller can calculate the sum of the current other characteristic forces and the current friction force to obtain the resultant force of the current single-body characteristic forces. Then, by subtracting this resultant force of the current single-body characteristic forces from the target output force, the target electromagnetic force is obtained. In a specific implementation, the controller can determine the direction of the mover based on the current travel and the travel at the previous moment.

Step A2022: when the current motion direction of the mover is the reverse motion direction, subtracting the difference between the current other characteristic forces and the current friction force from the target output force to obtain the target electromagnetic force of the force feedback apparatus.

When the current motion direction is the forward motion direction, the controller can calculate the difference between the current other characteristic forces and the current friction force to obtain the resultant force of the current single-body characteristic forces, and then subtract this resultant force of the current single-body characteristic forces from the target output force to obtain the target electromagnetic force.

Furthermore, in one implementation, when the current motion direction is stationary, i.e., the current travel is the same as the travel at the previous moment, the controller can use the driving mode of the previous moment as the target driving mode.

Furthermore, in one implementation, the preset driving mode is to output a forward voltage with a preset duty cycle, and step A204 includes:

Step A2041: calculating a ratio between the target electromagnetic force and the first estimated electromagnetic force, and determining a target duty cycle according to the ratio and the preset duty cycle.

In this implementation, there can only be one preset driving mode, specifically, to output a forward voltage with a preset duty cycle. After obtaining the target electromagnetic force and the first estimated electromagnetic force, the controller can calculate the ratio of the target electromagnetic force to the first estimated electromagnetic force, and then determine the target duty cycle based on this ratio and the preset duty cycle. Here, the target duty cycle represents the proportion of the target electromagnetic force relative to the electromagnetic force that the force feedback apparatus can output when driven with a forward voltage at a 100% duty cycle at the current travel.

In one implementation, the controller can multiply the ratio by a preset duty cycle and then divide by 100% to get the target duty cycle. It can be understood that when the preset duty cycle is 100%, the controller can directly determine the target duty cycle based on the ratio. Furthermore, in one implementation, when the target output force causes the calculated duty cycle to exceed the duty cycle range of the drive voltage (−100% to 100%), the duty cycle can be controlled within this range. Specifically, the controller can multiply the ratio by the preset duty cycle and then divide by 100% to get a percentage; if this percentage is greater than 100%, then 100% is set as the target duty cycle; if the percentage is less than −100%, then −100% is set as the target duty cycle; if the percentage is no more than 100% and no less than −100%, then the percentage is set as the target duty cycle.

Furthermore, in one implementation, when the current motion direction is the forward motion direction, the target duty cycle determined at the previous moment can be used as the target duty cycle at the current moment.

Step A2042: when the target duty cycle is greater than or equal to zero, setting “outputting a forward voltage with the target duty cycle” as the target driving mode;

Step A2043: when the target duty cycle is less than zero, setting “outputting a reverse voltage with a duty cycle equal to the absolute value of the target duty cycle” as the target driving mode.

When the target duty cycle is greater than or equal to zero, the controller can set “outputting a forward voltage with the target duty cycle” as the target driving mode. When the target duty cycle is less than zero, the controller can set “outputting a reverse voltage with the target duty cycle” as the target driving mode.

It can be understood that when the preset driving mode is to output a reverse voltage with a preset duty cycle, the method of determining the target driving mode is exactly the opposite of when the preset driving mode is to output a forward voltage with a preset duty cycle. This will not be further elaborated here.

Furthermore, in one implementation, when the preset driving mode is to output a forward voltage with a preset duty cycle, calculating the second estimated electromagnetic force can specifically involve multiplying the first estimated electromagnetic force by the target duty cycle to obtain the second estimated electromagnetic force. Furthermore, in one implementation, when the current motion direction is the forward motion direction, the estimated output force determined at the previous moment can be used as the estimated output force at the current moment.

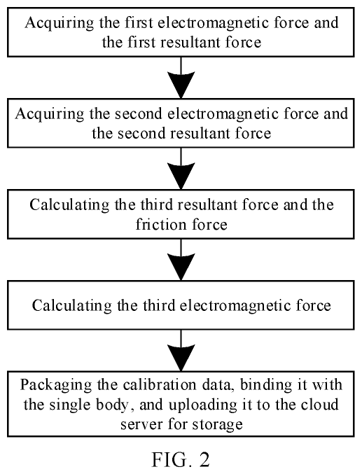

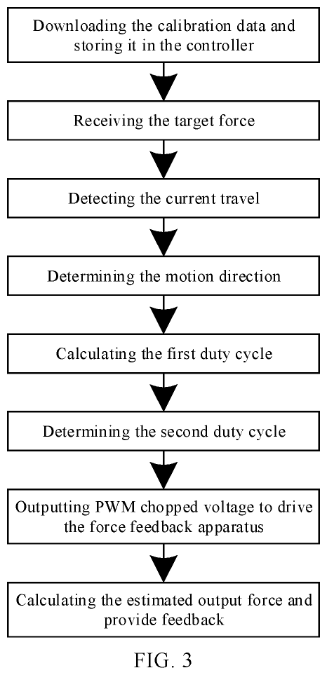

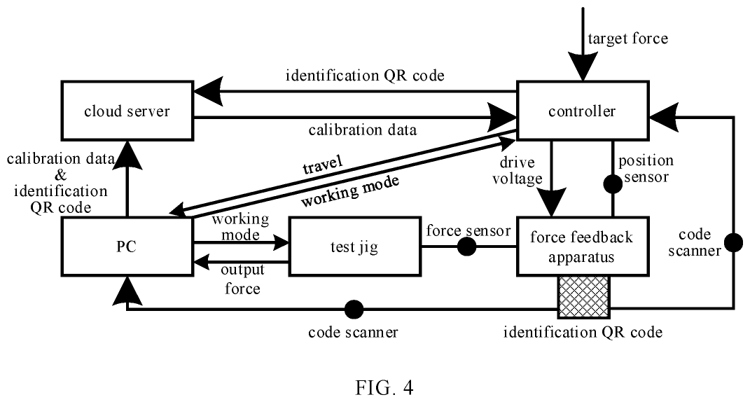

Furthermore, in one implementation, using a specific calibration and driving process of a force feedback apparatus as an example, the calibration procedure of a force feedback apparatus is shown in FIG. 2, the control flow is shown in FIG. 3, and the system diagram is shown in FIG. 4.

As shown in FIG. 2, the specific explanation of the calibration method of a force feedback apparatus in this implementation is as follows:
1) Obtain the first electromagnetic force Fe1 and the first resultant force Fa1. First, through testing the mover of the force feedback apparatus during its motion in the forward motion direction, collect the relationship data between the output force and the travel of the force feedback apparatus under no power and maximum forward current conditions (the relationship data refers to the correspondences in the aforementioned embodiments). Obtain the relationship data between the first electromagnetic force Fe1 and the travel and the relationship data between the resultant force (first resultant force Fa1) of the spring force Fk, static magnetic force Fm, and forward friction force Ff and the travel. As shown in FIG. 4, the specific process is:
1.1) The PC sends work mode 1 to the test jig and the controller, which means the test jig increases the travel S of the force feedback apparatus progressively from 0% travel in the forward direction up to 100% travel; the controller's drive voltage duty cycle is 0, meaning no power is supplied to control the force feedback apparatus.
1.2) The test jig detects the output force Fs1 of the force feedback apparatus over the full travel S via a force sensor (Note: Fs1 is a set of data curves related to the travel S, strictly speaking, it should be expressed as Fs1(S), but for convenience, it will be simplified to Fs1 in the following text, the representation of other forces will be similarly simplified). This force is the resultant force of the spring force Fk, static magnetic force Fm, and forward friction force Ff, i.e., the first resultant force Fa1, where Fa1=Fs1=Fk+Fm+Ff.
1.3) The PC sends work mode 2 to the test jig and the controller, which means the test jig increases the travel S of the force feedback apparatus progressively from 0% travel in the forward direction up to 100% travel; the controller's drive voltage duty cycle is 100%, meaning the maximum forward current is supplied to control the force feedback apparatus.
1.4) The test jig detects the output force Fs2 of the force feedback apparatus over the full travel S via a force sensor. This force is the resultant force of the first electromagnetic force Fe1, spring force Fk, static magnetic force Fm, and forward friction force Ff, i.e., Fs2=Fe1+Fk+Fm+Ff.
1.5) Based on the output forces Fs1 and Fs2, calculate the first electromagnetic force Fe1, i.e., Fe1=Fs2−Fs1.
2) Obtain the second electromagnetic force Fe2 and the second resultant force Fa2. Then, through testing the relationship data between the travel and the output force of the force feedback apparatus under no power and maximum forward current conditions during the process that the mover is moving in the reverse travel direction, obtain the relationship data between the second electromagnetic force Fe2 and the travel, and the relationship data between the resultant force (second resultant force Fa2) of the spring force Fk, static magnetic force Fm, and backward friction force −Ff and the travel. As shown in FIG. 4, the specific process is:
2.1) The PC sends work mode 3 to the test jig and the controller, which means the test jig decreases the travel S of the force feedback apparatus progressively from 100% travel in the reverse direction down to 0% travel; the controller's drive voltage duty cycle is 0, meaning no power is supplied to control the force feedback apparatus.
2.2) The test jig detects the output force Fs3 of the force feedback apparatus over the full travel S via a force sensor. This force is the resultant force of the spring force Fk, static magnetic force Fm, and reverse friction force −Ff, i.e., the second resultant force Fa2, where Fa2=Fs3=Fk+Fm−Ff.
2.3) The PC sends work mode 4 to the test jig and the controller, which means the test jig decreases the travel S of the force feedback apparatus progressively from 100% travel in the reverse direction down to 0% travel; the controller's drive voltage duty cycle is 100%, meaning the maximum forward current is supplied to control the force feedback apparatus.
2.4) The test jig detects the output force Fs4 of the force feedback apparatus over the full travel S via a force sensor. This force is the resultant force of the second electromagnetic force Fe2, spring force Fk, static magnetic force Fm, and reverse friction force −Ff, i.e., Fs4=Fe2+Fk+Fm−Ff.
2.5) Based on the output forces Fs3 and Fs4, calculate the second electromagnetic force Fe2, i.e., Fe2=Fs4−Fs3.
3) Calculate the third resultant force Fa3 and the friction force Ff. Based on the first resultant force Fa1 and the second resultant force Fa2, calculate the relationship data between the resultant force (third resultant force Fa3) of the spring force Fk and the static magnetic force Fm and the travel, and the relationship data between the friction force Ff and the travel. The specific process is:
3.1) Based on the first resultant force Fa1 and the second resultant force Fa2, calculate the resultant force of the spring force Fk and the static magnetic force Fm, i.e., the third resultant force Fa3, where Fa3=(Fa1+Fa2)/2.
3.2) Based on the first resultant force Fa1 and the second resultant force Fa2, calculate the friction force Ff, i.e., Ff=(Fa1−Fa2)/2.
4) Calculate the third electromagnetic force Fe3. Based on the first electromagnetic force Fe1 and the second electromagnetic force Fe2, calculate the third electromagnetic force Fe3, i.e., Fe3=(Fe1+Fe2)/2.
5) Package the calibration data, bind it with the single body, and upload it to the cloud server for storage. As shown in FIG. 4, package the relationship data between the third electromagnetic force Fe3, the third resultant force Fa3, and the friction force Ff and the travel as the calibration data package for the single body of the force feedback apparatus. After binding this data package with the QR code or other identification information of the force feedback apparatus single body, upload it to the cloud server for storage.

As shown in FIG. 3, the specific explanation of the driving method of a force feedback apparatus in this implementation is as follows:
1) Download the calibration data and store it in the controller. During actual controlling, the controller first downloads the corresponding calibration data package from the cloud server based on the QR code or other identification information of the current force feedback apparatus single body, and stores it in the controller. As shown in FIG. 4, the specific process is:
1.1) Use a code scanner to scan the QR code or other identification information of the current force feedback apparatus single body and transmit it to the controller.
1.2) The controller sends this identification information to the cloud server.
1.3) The cloud server sends the calibration data matching this identification information to the controller.
1.4) After the controller finishes downloading the calibration data, it saves it in the controller.
2) Receive the target force Ft (also referred to as the target output force in the above embodiments). As shown in FIG. 4, the controller receives the relationship data between the externally input target force Ft and the travel, where the upper limit of the externally input target force Ft is typically the rated output force FN of the force feedback apparatus; since the output force of the force feedback apparatus being less than 0N results in separation between the experiencer and the force output component of the apparatus, meaning there is no contact, that is, the experiencer cannot feel any force feedback less than 0N, in addition, considering control errors, the lower limit of the target force Ft is generally a value greater than 0N, such as 0.2N.
3) Detect the current travel S. The controller continuously detects the current travel of the mover of the force feedback apparatus through Hall elements or other position sensors. As shown in FIG. 4, the controller continuously detects the current travel S of the mover of the force feedback apparatus through a position sensor.
4) Determine the motion direction. The controller determines the motion direction of the current travel of the force feedback apparatus based on the currently detected travel Spresent and the previously detected travel Slast. Specifically:
4.1) If the currently detected travel Spresent is greater than the previously detected travel Slast, i.e., Spresent>Slast, then the direction of travel S is positive.
4.2) If the currently detected travel Spresent is less than the previously detected travel Slast, i.e., Spresent<Slast, then the direction of travel S is negative.
4.3) If the currently detected travel Spresent is equal to the previously detected travel Slast, i.e., Spresent=Slast, then the state of travel S is stationary.
5) Calculate the first duty cycle D1. The controller calculates the first duty cycle D1 required for the current travel based on the relationship data between the target force Ft, the third electromagnetic force Fe3, the third resultant force Fa3, and the friction force Ff and the travel, as well as the current travel S and the motion direction of the current travel. Specifically:
5.1) If the motion direction of the current travel is positive, then the first duty cycle D1=[Ft−(Fa3+Ff)]/Fe3.
5.2) If the motion direction of the current travel is negative, then the first duty cycle D1=[Ft−(Fa3−Ff)]/Fe3.
5.3) If the state of the current travel is stationary, then the first duty cycle D1 remains the same as the last calculated value.
6) Determine the second duty cycle D2. The controller performs an amplitude check on the first duty cycle D1. If the first duty cycle D1 is greater than 100%, then adjust the first duty cycle D1 to 100%; if the first duty cycle D1 is less than −100%, then adjust the first duty cycle D1 to −100%; otherwise, keep the first duty cycle D1 unchanged. Define the adjusted first duty cycle D1 as the second duty cycle D2. Specifically:
6.1) If D1>100%, then D2=100%.
6.2) If D1<−100%, then D2=−100%.
6.3) If −100%≤D1≤100%, then D2=D1.
7) Output PWM chopped voltage to drive the force feedback apparatus. Specifically:
7.1) The controller checks the polarity of the second duty cycle D2. If the second duty cycle D2 is greater than or equal to 0, i.e., D2≥0, then output a forward voltage with an amplitude equal to the DC power supply voltage Udc, and the duty cycle D is the second duty cycle D2.
7.2) If the second duty cycle D2 is less than 0, i.e., D2<0, then output a reverse voltage with an amplitude equal to the DC power supply voltage Udc, and the duty cycle D is the absolute value of the second duty cycle |D2|.
7.3) The controller generates the PWM chopped voltage according to the above method to control the actual force output of the force feedback apparatus.
8) Calculate the estimated output force Fb and provide feedback. The controller calculates the relationship data between the estimated output force Fb and the travel based on the relationship data between the third electromagnetic force Fe3, the third resultant force Fa3, the friction force Ff and the travel, as well as the second duty cycle D2 and the motion direction of the current travel. This data can be fed back to the screen for plotting display or batch stored for subsequent analysis. Specifically:
8.1) If the motion direction of the current travel is positive, then the estimated output force Fb=D2*Fe3+Fa3+Ff.
8.2) If the motion direction of the current travel is negative, then the estimated output force Fb=D2*Fe3+Fa3−Ff.
8.3) If the state of the current travel is stationary, then the estimated output force Fb remains the same as the last calculated value.

The estimated output force Fb is fed back to the screen for plotting display or batch stored for subsequent analysis.

In one embodiment, the calibration device for the force feedback apparatus of the present invention can include: a processor, such as a CPU, a network interface, a user interface, a memory, and a communication bus. The user interface can include a display (Display) and an input unit like a keyboard (Keyboard); optionally, the user interface may also include standard wired interfaces and wireless interfaces. The network interface optionally may include standard wired interfaces and wireless interfaces (such as a Wi-Fi interface). The memory can be high-speed RAM memory or stable storage (non-volatile memory), such as disk storage. Optionally, the memory may also be a storage device independent of the aforementioned processor.

As a computer storage medium, the memory can include an operating system, a network communication module, a user interface module, and a calibration program for the force feedback apparatus. The operating system is a program that manages and controls the hardware and software resources of the device, supporting the operation of the calibration program for the force feedback apparatus and other software or programs. The user interface is mainly used for data communication with the client; the network interface is mainly used for establishing a communication connection with the server. The processor can be used to call the calibration program for the force feedback apparatus stored in the memory and execute the following operations:
when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus, wherein the single-body characteristic forces are outward output forces caused by single-body characteristics of the force feedback apparatus;
when the force feedback apparatus is driven according to a preset driving mode, adjusting the travel of the mover via the test jig and measuring the outward output force of the force feedback apparatus via the force sensor, in order to, taking into account the first correspondence, measure a second correspondence between an electromagnetic force and the travel of the force feedback apparatus under the preset driving mode; and
outputting the first correspondence and the second correspondence, in order to enable a controller of the force feedback apparatus to determine a target driving mode according to a current travel of the mover, a target output force, the first correspondence, and the second correspondence, and to drive the force feedback apparatus according to the target driving mode.

Further, the operation “when the force feedback apparatus is not powered on, adjusting a travel of a mover of the force feedback apparatus via a test jig and measuring an outward output force of the force feedback apparatus via a force sensor, in order to measure a first correspondence between single-body characteristic forces and the travel of the force feedback apparatus” comprises:
when the force feedback apparatus is not powered on, adjusting a travel of a mover of the force feedback apparatus in the forward motion direction via a test jig and measuring an outward output force of the force feedback apparatus via a force sensor, in order to measure a third correspondence between a resultant force of single-body characteristic forces and the travel of the force feedback apparatus;
when the force feedback apparatus is not powered on, adjusting the travel of the mover in the reverse motion direction via the test jig and measuring the outward output force of the force feedback apparatus via the force sensor, in order to measure a fourth correspondence between a resultant force of the single-body characteristic forces and the travel; and
calculating a fifth correspondence between a friction force and the travel of the force feedback apparatus and a sixth correspondence between other characteristic forces and the travel of the force feedback apparatus based on the third correspondence and the fourth correspondence, and using the fifth correspondence and the sixth correspondence as the first correspondence;
wherein the friction force is one type of the single-body characteristic forces, and the other characteristic forces are the remaining forces of the single-body characteristic forces excluding the friction force.

Further, the operation of “outputting the first correspondence and the second correspondence” comprises:
acquiring identification information of the force feedback apparatus; and
binding the first correspondence and the second correspondence with the identification information before uploading them to a preset server, in order to enable the controller of the force feedback apparatus to retrieve the first correspondence and the second correspondence from the preset server according to the identification information.

In one embodiment, the driving device for the force feedback apparatus of the present invention can include: a processor, such as a CPU, a network interface, a user interface, a memory, and a communication bus. The user interface can include a display (Display) and an input unit such as a keyboard (Keyboard); optionally, the user interface may also include standard wired interfaces and wireless interfaces. The network interface optionally may include standard wired interfaces and wireless interfaces (such as a Wi-Fi interface). The memory can be high-speed RAM memory or stable storage (non-volatile memory), such as disk storage. Optionally, the memory may also be a storage device independent of the aforementioned processor.

As a computer storage medium, the memory can include an operating system, a network communication module, a user interface module, and a driving program for the force feedback apparatus. The operating system is a program that manages and controls the hardware and software resources of the device, supporting the operation of the driving program for the force feedback apparatus and other software or programs. The user interface is primarily used for data communication with the client; the network interface is primarily used for establishing a communication connection with the server. The processor can be configured to call the driving program for the force feedback apparatus stored in the memory and execute the following operations:
acquiring a current travel of a mover of the force feedback apparatus and a target output force corresponding to the current travel;
determining a target driving mode according to the current travel, the target output force, a first correspondence, and a second correspondence, wherein the first correspondence is a correspondence between single-body characteristic forces and a travel of the mover of the force feedback apparatus, the second correspondence is a correspondence between an electromagnetic force and the travel of the mover of the force feedback apparatus under a preset driving mode, and the single-body characteristic forces are outward output forces caused by single-body characteristics of the force feedback apparatus; and
driving the force feedback apparatus according to the target driving mode.

Further, the operation of “determining a target driving mode according to the current travel, the target output force, a first correspondence, and a second correspondence” comprises:
determining current single-body characteristic forces corresponding to the current travel according to the first correspondence;
determining a target electromagnetic force of the force feedback apparatus according to the target output force and the current single-body characteristic forces;
determining a first estimated electromagnetic force corresponding to the current travel under the preset driving mode according to the second correspondence; and
determining a target driving mode according to the target electromagnetic force and the first estimated electromagnetic force.

Further, after the operation of “determining a target driving mode according to the current travel, the target output force, a first correspondence, and a second correspondence”, the processor can be configured to call the driving program for the force feedback apparatus stored in the memory and execute the following operations:
determining a second estimated electromagnetic force of the force feedback apparatus under the target driving mode and the current travel according to the first estimated electromagnetic force and the target driving mode;
determining an estimated output force of the force feedback apparatus according to the second estimated electromagnetic force and the current single-body characteristic forces; and
generating relational data representing a correspondence between the estimated output force and the current travel, and outputting the relational data.

Further, the operation of “determining current single-body characteristic forces corresponding to the current travel according to the first correspondence” comprises:
determining a current friction force corresponding to the current travel according to a fifth correspondence included in the first correspondence;
determining current other characteristic forces corresponding to the current travel according to a sixth correspondence included in the first correspondence;
wherein the fifth correspondence is a correspondence between a friction force and the travel of the mover of the force feedback apparatus, and the sixth correspondence is a correspondence between other characteristic forces and the travel of the mover of the force feedback apparatus, the friction force being one type of the single-body characteristic forces, and the other characteristic forces being the remaining forces of the single-body characteristic forces excluding the friction force;
the operation of “determining a target electromagnetic force of the force feedback apparatus according to the target output force and the current single-body characteristic forces” comprises:
when the current motion direction of the mover is the forward motion direction, subtracting the sum of the current other characteristic forces and the current friction force from the target output force to obtain the target electromagnetic force of the force feedback apparatus;
when the current motion direction of the mover is the reverse motion direction, subtracting the difference between the current other characteristic forces and the current friction force from the target output force to obtain the target electromagnetic force of the force feedback apparatus.

Further, the preset driving mode is to output a forward voltage with a preset duty cycle, the operation of “determining a target driving mode according to the target electromagnetic force and the first estimated electromagnetic force” comprises:
calculating a ratio between the target electromagnetic force and the first estimated electromagnetic force, and determining a target duty cycle according to the ratio and the preset duty cycle;
when the target duty cycle is greater than or equal to zero, setting “outputting a forward voltage with the target duty cycle” as the target driving mode;
when the target duty cycle is less than zero, setting “outputting a reverse voltage with a duty cycle equal to the absolute value of the target duty cycle” as the target driving mode.

Further, before the operation of “acquiring a current travel of a mover of the force feedback apparatus and a target output force corresponding to the current travel”, the processor can also be used to call the driving program for the force feedback apparatus stored in the memory and execute the following operations:
acquiring identification information of the force feedback apparatus; and
downloading the first correspondence and the second correspondence corresponding to the identification information from a preset server.

In addition, the embodiments of the present invention propose a computer-readable storage medium, wherein the storage medium stores a calibration program for the force feedback apparatus. When the calibration program for the force feedback apparatus is executed by a processor, it implements the steps of the calibration method for the force feedback apparatus described herein. All embodiments of the calibration equipment for the force feedback apparatus and the computer-readable storage medium of the present invention can refer to the various embodiments of the calibration method for the force feedback apparatus, and they will not be elaborated here.

Moreover, the embodiments of the present invention propose a computer-readable storage medium, wherein the storage medium stores a driving program for the force feedback apparatus. When the driving program for the force feedback apparatus is executed by a processor, it implements the steps of the driving method for the force feedback apparatus described herein. All embodiments of the driving equipment for the force feedback apparatus and the computer-readable storage medium of the present invention can refer to the various embodiments of the driving method for the force feedback apparatus, and they will not be elaborated here.

It should be noted that in this document, the terms “include” and “comprise” or their variants are intended to cover non-exclusive inclusion, so that a process, method, item, or apparatus that includes a series of elements not only includes those elements but also includes other elements not explicitly listed, or may include inherent elements of such a process, method, item, or apparatus. In the absence of more limitations, an element defined by the phrase “including a . . . ” does not exclude the possibility of additional identical elements in the process, method, item, or apparatus that includes the element.

The serial numbers of the embodiments of the present invention are merely for descriptive purposes and do not represent the superiority or inferiority of the embodiments.

Through the description of the above embodiments, those skilled in the art can clearly understand that the above embodiments of the methods can be implemented through software plus necessary general hardware platforms. Of course, they can also be implemented through hardware, but in many cases, the former is a better implementation. Based on this understanding, the technical solutions of the present invention, essentially or the part that makes contributions to the existing technology, can be embodied in the form of a software product, which is stored in a storage medium (such as ROM/RAM, magnetic disk, optical disk), including several instructions to make a terminal device (which can be a mobile phone, a computer, a server, an air conditioner, or a network device, etc.) perform the methods described in the embodiments of the present invention.

The foregoing merely describes preferred embodiments of the present invention and is not intended to limit the scope of the patent of the present invention. Any modifications or equivalent substitutions made within the spirit and principles of the present invention shall fall within the scope of protection of the present invention.

1. A calibration method for a force feedback apparatus, wherein the force feedback apparatus is based on electromagnetic direct drive, the method comprising:
when the force feedback apparatus is not powered on, adjusting a travel of a mover of the force feedback apparatus via a test jig and measuring an outward output force of the force feedback apparatus via a force sensor, to measure a first correspondence between single-body characteristic forces and the travel of the force feedback apparatus, wherein the single-body characteristic forces comprise outward output forces caused by single-body characteristics of the force feedback apparatus;
when the force feedback apparatus is driven according to a preset driving mode, adjusting the travel of the mover via the test jig and measuring the outward output force of the force feedback apparatus via the force sensor to measure a second correspondence between an electromagnetic force and the travel of the force feedback apparatus under the preset driving mode in consideration of the first correspondence; and
outputting the first correspondence and the second correspondence, to allow a controller of the force feedback apparatus to determine a target driving mode according to a current travel of the mover, a target output force, the first correspondence, and the second correspondence, and to drive the force feedback apparatus according to the target driving mode.

2. The calibration method for a force feedback apparatus according to claim 1, wherein the adjusting a travel of a mover of the force feedback apparatus via a test jig and measuring an outward output force of the force feedback apparatus via a force sensor, to measure a first correspondence between single-body characteristic forces and the travel of the force feedback apparatus, comprises:
when the force feedback apparatus is not powered on, adjusting a travel of a mover of the force feedback apparatus in a forward motion direction via a test jig and measuring an outward output force of the force feedback apparatus via a force sensor, to measure a third correspondence between a resultant force of single-body characteristic forces and the travel of the force feedback apparatus;
when the force feedback apparatus is not powered on, adjusting the travel of the mover in a reverse motion direction via the test jig and measuring the outward output force of the force feedback apparatus via the force sensor, to measure a fourth correspondence between a resultant force of the single-body characteristic forces and the travel; and
calculating a fifth correspondence between a friction force and the travel of the force feedback apparatus based on the third correspondence and the fourth correspondence, calculating a sixth correspondence between other characteristic forces and the travel of the force feedback apparatus based on the third correspondence and the fourth correspondence, and using the fifth correspondence and the sixth correspondence as the first correspondence;
wherein the friction force comprises one type of the single-body characteristic forces, and the other characteristic forces are the remaining forces of the single-body characteristic forces excluding the friction force.

3. The calibration method for a force feedback apparatus according to claim 1, wherein the outputting the first correspondence and the second correspondence comprises:
acquiring identification information of the force feedback apparatus; and
binding the first correspondence and the second correspondence with the identification information before uploading them to a preset server, activate the controller of the force feedback apparatus to retrieve the first correspondence and the second correspondence from the preset server according to the identification information.

4. A driving method for a force feedback apparatus, wherein the force feedback apparatus is based on electromagnetic direct drive, comprising:
acquiring a current travel of a mover of the force feedback apparatus and a target output force corresponding to the current travel;
determining a target driving mode according to the current travel, the target output force, a first correspondence, and a second correspondence, wherein the first correspondence comprises a correspondence between single-body characteristic forces and a travel of the mover of the force feedback apparatus, the second correspondence comprises a correspondence between an electromagnetic force and the travel of the mover of the force feedback apparatus under a preset driving mode, and the single-body characteristic forces comprises outward output forces caused by single-body characteristics of the force feedback apparatus; and
driving the force feedback apparatus according to the target driving mode.

5. The driving method for a force feedback apparatus according to claim 4, wherein the determining a target driving mode according to the current travel, the target output force, a first correspondence, and a second correspondence comprises:
determining current single-body characteristic forces corresponding to the current travel according to the first correspondence;
determining a target electromagnetic force of the force feedback apparatus according to the target output force and the current single-body characteristic forces;
determining a first estimated electromagnetic force corresponding to the current travel under the preset driving mode according to the second correspondence; and
determining a target driving mode according to the target electromagnetic force and the first estimated electromagnetic force.

6. The driving method for a force feedback apparatus according to claim 5, wherein after the determining a target driving mode according to the current travel, the target output force, a first correspondence, and a second correspondence, further comprises:
determining a second estimated electromagnetic force of the force feedback apparatus under the target driving mode and the current travel according to the first estimated electromagnetic force and the target driving mode;
determining an estimated output force of the force feedback apparatus according to the second estimated electromagnetic force and the current single-body characteristic forces; and
generating relational data representing a correspondence between the estimated output force and the current travel, and outputting the relational data.

7. The driving method for a force feedback apparatus according to claim 5, wherein the determining current single-body characteristic forces corresponding to the current travel according to the first correspondence comprises:
determining a current friction force corresponding to the current travel according to a fifth correspondence included in the first correspondence;
determining current other characteristic forces corresponding to the current travel according to a sixth correspondence included in the first correspondence;
wherein the fifth correspondence comprises a correspondence between a friction force and the travel of the mover of the force feedback apparatus, and the sixth correspondence comprises a correspondence between other characteristic forces and the travel of the mover of the force feedback apparatus, the friction force comprising one type of the single-body characteristic forces, and the other characteristic forces comprising the remaining forces of the single-body characteristic forces excluding the friction force;
the determining a target electromagnetic force of the force feedback apparatus according to the target output force and the current single-body characteristic forces comprises:
when the current motion direction of the mover is a forward motion direction, subtracting the sum of the current other characteristic forces and the current friction force from the target output force to obtain the target electromagnetic force of the force feedback apparatus;
when the current motion direction of the mover is a reverse motion direction, subtracting the difference between the current other characteristic forces and the current friction force from the target output force to obtain the target electromagnetic force of the force feedback apparatus.

8. The driving method for a force feedback apparatus according to claim 5, wherein the preset driving mode is to output a forward voltage with a preset duty cycle, and the determining a target driving mode according to the target electromagnetic force and the first estimated electromagnetic force comprises:
calculating a ratio between the target electromagnetic force and the first estimated electromagnetic force, and determining a target duty cycle according to the ratio and the preset duty cycle;
when the target duty cycle is greater than or equal to zero, setting “outputting a forward voltage with the target duty cycle” as the target driving mode;
when the target duty cycle is less than zero, setting outputting a reverse voltage with a duty cycle equal to the absolute value of the target duty cycle as the target driving mode.

9. The driving method for a force feedback apparatus according to claim 4, wherein before the acquiring a current travel of a mover of the force feedback apparatus and a target output force corresponding to the current travel, the method further comprises:
acquiring identification information of the force feedback apparatus; and
downloading the first correspondence and the second correspondence corresponding to the identification information from a preset server.

10. A calibration device for a force feedback apparatus, comprising:
a memory;
a processor; and
a calibration program for the force feedback apparatus stored on the memory and operable on the processor;
wherein the calibration program, when executed by the processor, implements a calibration method for the force feedback apparatus of claim 1.

11. A driving device for a force feedback apparatus, comprising:
a memory;
a processor; and
a driving program for the force feedback apparatus stored on the memory and operable on the processor;
wherein the driving program, when executed by the processor, implements a driving method for the force feedback apparatus of claim 4.

12. A computer-readable storage medium, characterized comprising a calibration program for a force feedback apparatus stored thereon, wherein the calibration program, when executed by a processor, implements a method for the force feedback apparatus of claim 1.

13. A computer-readable storage medium, comprising a driving program for a force feedback apparatus stored thereon, wherein the driving program, when executed by a processor, implements a driving method for the force feedback apparatus of claim 4.
